(19) United States
(12) Patent Application Publication
(10) Pub. No.: US 2005/0248690 A1
(43) Pub. Date: Nov. 10, 2005

(54) Projection television

(76) Inventor: Sang-ik Kim, Suwon-si (KR)

Correspondence Address: STANZIONE & KIM, LLP, 919 18TH STREET, N.W., SUITE 440, WASHINGTON, DC, 20006, US

(21) Appl. No.: 10/964,710

(22) Filed: Oct. 15, 2004

(30) Foreign Application Priority Data
May 8, 2004 (KR) 2004-32512

(51) Int. Cl. G02B 7/00; H04N 5/64

(52) U.S. Cl. 348/743; 348/744; 359/892

(57) ABSTRACT

A projection television includes a light source, a color wheel to selectively transmit light from the light source, an engine housing mounted with the color wheel, a color wheel housing coupled to the engine housing to accommodate the color wheel, a holder detachably coupled to the color wheel housing to rotatably support the color wheel, a coupling part to couple the holder to the color wheel housing, a first buffer provided between the holder and the color wheel housing to prevent vibration generated by the color wheel from being transmitted to the color wheel housing through the holder, a second buffer provided between the color wheel housing and the engine housing to prevent the vibration generated by the color wheel from being transmitted to the engine housing through the color wheel housing. The projection television having the color wheel housing protects the color wheel coupled to the holder which can be detachably coupled to the color wheel housing, thereby minimizing noise generating due to vibration of the color wheel.

### CROSS-REFERENCE TO RELATED APPLICATIONS

This application claims the benefit of Korean Patent Application No. 2004-32512, filed on Mar. 8, 2004, in the Korean Intellectual Property Office, the disclosure of which is incorporated herein in its entirety and by reference.

### BACKGROUND OF THE INVENTION

1. Field of the Invention

The present general inventive concept relates to a projection television, and more particularly, to a projection television having an improved color wheel structure to reduce noise occurring due to rotation of a color wheel.

2. Description of the Related Art

Generally, a projection television displays a large-sized image by applying the principle of a projector projecting an image beam onto a screen by using a mirror and an optical lens. The projection television is classified into a cathode ray tube (CRT) type, a liquid crystal display (LCD) type, a digital light processing (DLP) type, etc., according to a display device displaying signal image information.

The projection television comprises a light source emitting white light and a color wheel disposed adjacent to the light source to selectively transmit red (R), green (G) and blue (B) light from the white light. A rotating plate of the color wheel rotates at a high speed over 9000 RPM, so that noise generates due to a rotation of the rotating plate, and vibration is also generated from a shaft supporting the rotating plate during the rotation of the rotating plate.

A conventional stationary structure of a color wheel unit is disclosed in FIG. 7.

As shown in FIG. 7, the conventional stationary structure of the color wheel unit comprises a base 280, a holder 290 fixing a color wheel 265 to the base 280, a buffer 210 provided between the base 280 and the holder 290 to decrease the noise generating from the color wheel 265 by absorbing vibration of the color wheel 265, and a screw 240 coupling the base 280 to the holder 290 and the buffer 210 to fix the holder 290 to the base 280.

With this configuration, the conventional stationary structure of the color wheel unit may reduce the noise generating due to the vibration of the color wheel 265.

However, because the buffer is shaped like a plate and is exposed in the conventional stationary structure of the color wheel unit, the conventional stationary structure of the color wheel unit has a limitation in preventing the noise generating due to the vibration of the color wheel 265 although a portion of the vibration generating during the rotation of the color wheel 265 can be prevented from being transmitted to the base through the folder 290.

### SUMMARY OF THE INVENTION

In order to solve the foregoing and/or other problems, it is an aspect of the present general inventive concept to provide a projection television comprising a color wheel housing to protect a color wheel coupled to a holder which can be detachably attached to the color wheel housing, and to minimize noise generating due to vibration of the color wheel.

Additional aspects and/or advantages of the general inventive concept will be set forth in part in the description which follows and, in part, will be obvious from the description, or may be learned by practice of the general inventive concept.

The foregoing and/or other aspects and advantages of the present general inventive concept may be achieved by providing a projection television comprising a light source, a color wheel to selectively transmit light emitted from the light source, an engine housing mounted with the color wheel, a color wheel housing coupled to the engine housing to accommodate the color wheel, a holder detachably attached to the color wheel housing to rotatably support the color wheel, a coupling part to couple the holder to the color wheel housing, a first buffer provided between the holder and the color wheel housing to prevent vibration generated by the color wheel from being transmitted to the color wheel housing through the holder, a second buffer provided between the color wheel housing and the engine housing to prevent the vibration generated by the color wheel from being transmitted to the engine housing through the color wheel housing.

According to an aspect of the general inventive concept, a light tunnel may be provided in the engine housing to uniformize the light passing through the color wheel, and the second buffer may comprise a body to be in contact with the color wheel housing and the engine housing, and an extending part extended from the body to receive the light tunnel.

According to another aspect of the general inventive concept, the projection television may further comprise a third buffer provided between the coupling part and the holder to prevent the vibration generated by the color wheel from being transmitted to the coupling part through the holder.

According to yet another aspect of the general inventive concept, the projection television may further comprise a sliding projection formed in one of the engine housing and the color wheel housing to enable the color wheel housing to slide with respect to the engine housing 70, and a sliding groove formed in the other one of the engine housing and the color wheel housing and coupled to the sliding projection.

According to still another aspect of the general inventive concept, the projection television may further comprise a coupling projection formed in one of the engine housing and the color wheel housing to couple the color wheel housing to the engine housing, and a projection groove formed in the other one of the engine housing and the color wheel housing to accommodate the coupling projection.

According to another aspect of the general inventive concept, a plurality of fins can be formed on a portion of the color wheel housing to dissipate heat generated from the color wheel housing or the color wheel.

The foregoing and/or other aspects and advantages of the present general inventive concept may also be achieved by providing a projection television comprising a color wheel, a holder coupled to the color wheel to rotatably support the color wheel, a color wheel housing detachably coupled to the holder to accommodate the color wheel, and a first buffer provided between the holder and the color wheel housing.

According to an aspect of the general inventive concept, the projection television may further comprise an engine housing to accommodate the color wheel housing, and a second buffer provided between the color wheel housing and the engine housing.

According to another aspect of the general inventive concept, the projection television further may comprise a coupling part to couple the holder to the color wheel housing, and a third buffer provided between the coupling part and the holder.

### BRIEF DESCRIPTION OF THE DRAWINGS

These and other aspects and advantages of the general inventive concept will become apparent and more readily appreciated from the following description of the embodiments, taken in conjunction with the accompany drawings of which:

FIG. 1 is a schematic view illustrating a projection television according to an embodiment of the present general inventive concept;

FIG. 2 is a combined perspective view illustrating a lamp assembly and an optical engine unit used with a projection television according to another embodiment of the present general inventive concept;

FIG. 3 is a partially exploded perspective view illustrating the lamp assembly and the optical engine unit of FIG. 2;

FIG. 4 is an exploded perspective view schematically illustrating an engine housing used with a projection television according to another embodiment of the present general inventive concept;

FIG. 5 is a perspective view illustrating a process of coupling a holder having a color wheel to a color wheel housing in a projection television according to another embodiment of the present general inventive concept;

FIG. 6 is a combined perspective view illustrating a state in which a color wheel housing is coupled to an engine housing in a projection television according to another embodiment of the present general inventive concept; and

FIG. 7 is a perspective view illustrating a conventional stationary structure of a color wheel in a projection television.

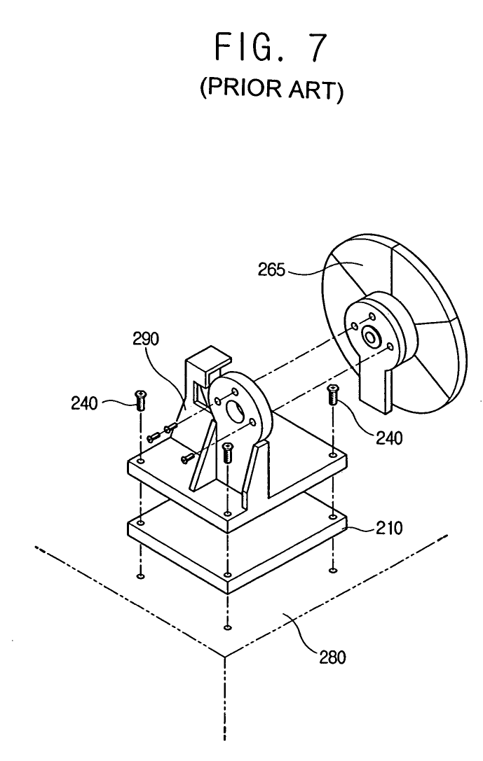

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to like elements throughout. The embodiments are described below so as to explain the present general inventive concept by referring to the figures.

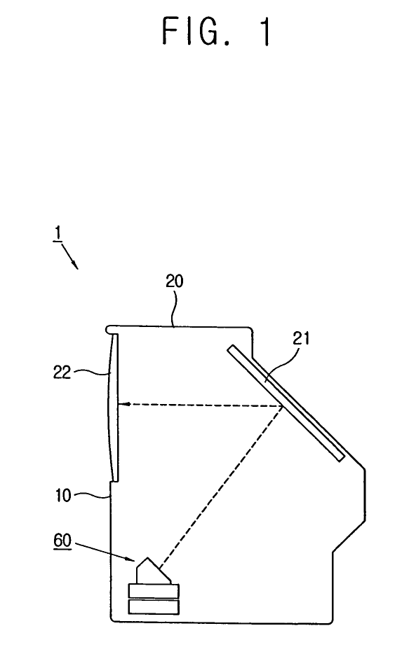

As shown in FIG. 1, a projection television 1 according to an embodiment of the present general inventive concept may comprise a main body 10 including an optical engine unit 60 therein, and a displayer 20 provided on a top of the main body 10 to display an image on a screen 22 using an image beam projected by the optical engine unit 60 and then reflected by a reflecting mirror 21.

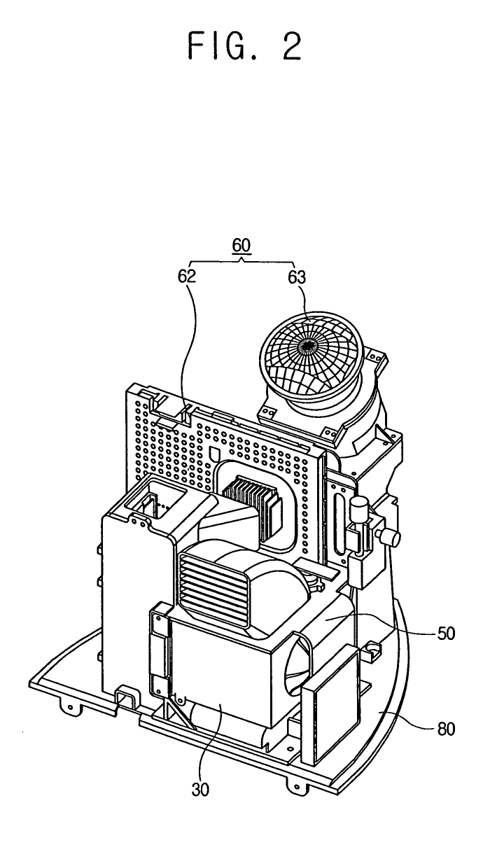

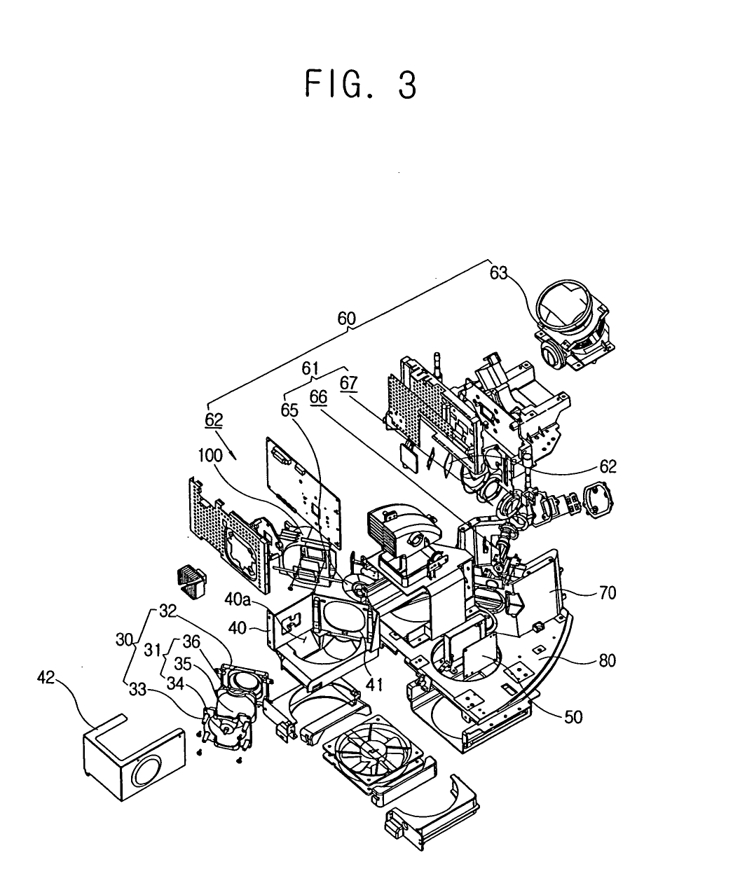

As shown in FIGS. 2 and 3, the main body 10 may comprise at an inside thereof a lamp assembly 30 including a light source 31 to emit light, a light source accommodator 40 to accommodate the lamp assembly 30, a shield 42 provided in a rear side of the light source accommodator 40 to protect the light source 31, a light source housing 50 to accommodate the light source accommodator 40 coupled to the lamp assembly 30, the optical engine unit 60 including a color wheel 65 and a light tunnel 66 to project the image beam onto the screen 22 by dividing and composing the light emitted from the lamp assembly 30, and an engine housing 70 to accommodate the optical engine unit 60. These components are mounted to a base bracket 80 provided at a bottom of the main body 10.

The lamp assembly 30 may comprise the light source 31 including a lamp 34, a front-supporter 32 coupled to a front side of the light source 31 to support the light source 31, and a back-supporter 33 coupled to a rear side of the light source 31 to support the light source 31.

Generally, the light source 31 may comprise an arc discharging lamp, such as a mercury lamp, a metal halide lamp, or a xenon lamp, and the light source 31 may comprise other kinds of lamps than the arc discharging lamp. The light source 31 may comprise the lamp 34 to emit the light, a reflector 35 coupled to the lamp 34 enclosed therein to reflect and focus the light from the lamp 34, and a cover 36 provided in front of the lamp 34.

The light source accommodator 40 can be formed with an accommodating space 40a so as to accommodate the light source 31 supported by the front-supporter 32 and the back-supporter 33, and an opening part 41 through which the light of the light source 31 passes.

The light source housing 50 can be shaped to correspond to the light source accommodator 40 to accommodate the light source accommodator 40.

The optical engine unit 60 may comprise an optical system 61, a panel 62, a projecting lens 63, etc.

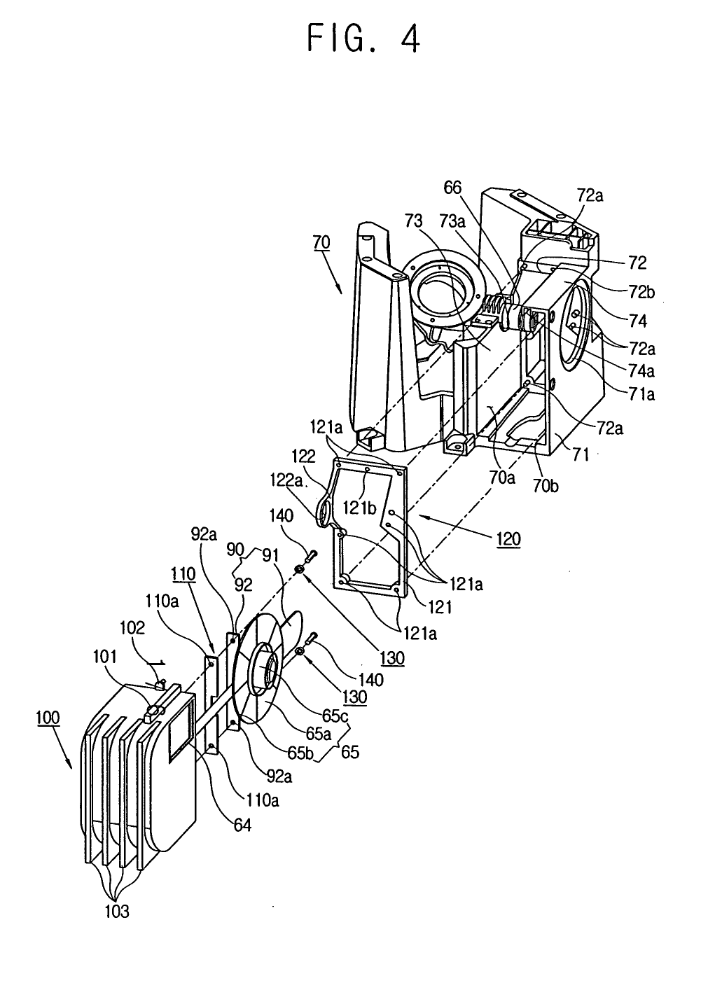

The optical system 61 can be provided inside the engine housing 70 and may comprise a UV filter (refer to reference numeral 64 in FIG.4) to block off ultraviolet rays constituting the light of which infrared rays are blocked off by the reflector 35 of the light source 31, the color wheel 65 to selectively transmit red (R), green (G) and blue (B) color-light composing the light passing through the UV filter 64, the light tunnel 66 to uniformize the red (R), green (G) and blue (B) color-light generated from the color wheel 65, and a lens group 67 including a dichroic mirror, a micro lens, etc., to divide and reflect the red (R), green (G) and blue (B) color-light, which has passed the light tunnel 66, and to control the red (R), green (G) and blue (B) color-light to be incident on corresponding ones of pixels.

A digital micro mirror device (DMD) can be provided in the panel 62. The DMD can adjust a reflecting angle per one pixel to modulate the color-light into the image beam using the light projected from the lens group 67 of the optical system 61.

The projecting lens 63 can project the image beam modulated at the panel 62 toward the reflecting mirror 21, and the reflecting mirror 21 can reflect the image beam to the screen 22 so that the image is displayed on the displayer 20, as shown in FIGS. 1 and 2.

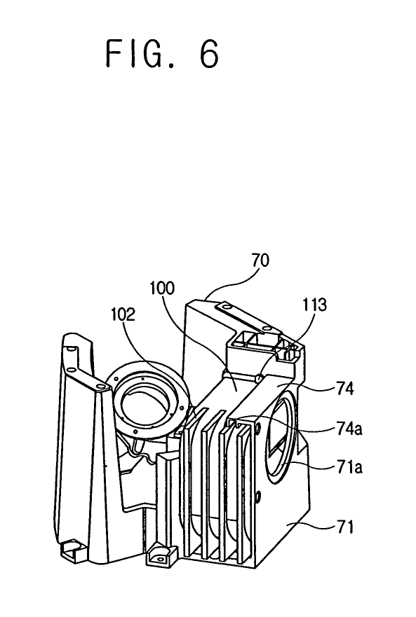

As shown in FIGS. 4 through 6, the engine housing 70 can be formed with a side opening part 70b and a housing accommodator 70a so as to accommodate a color wheel housing 100 from a side of the engine housing 70. A light passage 71a can be formed in a front part 71 of the engine housing 70 to provide a passage to the light generated from the light source 31, and a skirt 74 can be disposed on a top of the front part 71 and can be bent backward. A plurality of projections 72a can be formed on a side part 72 of the engine housing 70, and a light tunnel seat 73a can be formed on a back part 73 thereof so that the light tunnel 66 is disposed on the light tunnel seat 73a.

The color wheel 65 may comprise a color filter (color filters) 65a sequentially disposed along a circular direction thereof, a rotating plate 65b to rotate together with the color filters 65a so as to sequentially dispose a corresponding one of the color filters 65a on a light-path, and a rotation power supply 65c to drive the rotating plate 65b to rotate. Noise due to rotation and vibration of a shaft supporting the rotating plate 65b can be generated when the rotating plate 65b of the color wheel 65 rotates at high speed over 9000 RPM.

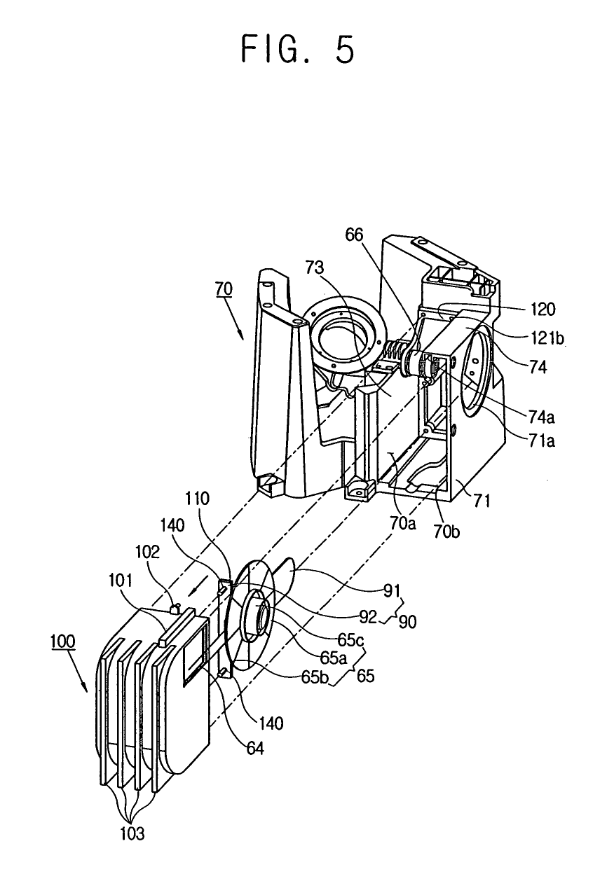

The projection television 1 may further comprise a holder 90 to rotatably support the color wheel 65, and the color wheel housing 100 coupled to the engine housing 70 to accommodate the color wheel 65. The holder 90 mounted with the color wheel 65 can be detachably coupled (attached) to the color wheel housing 100 by pushing the color wheel 65 into an inside of the color wheel housing 100 in a direction of an arrow in FIG. 5. Here, a first buffer 110 can be provided in a connection part between the holder 90 and the color wheel housing 100 so that the vibration generated by the color wheel 65 is prevented from being transmitted to the color wheel housing 100 through the holder 90. Accordingly, the noise occurring due to the rotation of the color wheel 65 can be minimized.

The holder 90 can be of a T-shape and may comprise a power supply coupling part 91 coupled to the rotation power supply 65c of the color wheel 65, and a housing coupling part 92 coupled to an inside of the color wheel housing 100. The holder 90 can be coupled to the color wheel housing 100 by a coupling part 140. A third buffer 130 can prevent the vibration generated by the color wheel 65 from being transmitted to the coupling part 140 through the holder 90. The third buffer 130 can be provided between the housing coupling part 92 of the holder 90 and coupling part 140.

The color wheel housing 100 can be of a rectangular cylinder-shape and can accommodate the color wheel 65 coupled to the holder 90. The color wheel housing 100 can be provided with a plurality of fins 103 at a side thereof to cool down the color wheel housing 100 and the color wheel 65 by dissipating heat generated from the color wheel housing 100 and the color wheel 65. Accordingly, the heat generated by the rotation of the color wheel 65 can efficiently be emitted outside the color wheel 100.

Meanwhile, the first buffer 110 can be provided between the holder 90 and the color wheel housing 100 and can prevent the vibration generated by the color wheel 65 from being transmitted to the color wheel housing 100 through the holder 90. The first buffer 110 can be shaped to correspond to the housing coupling part 92 so as to absorb the vibration of the color wheel 65 at maximum by being in surface-contact with the housing coupling part 92.

Through holes 92a and 110a through which the coupling part 140 passes are respectively formed in the housing coupling part 92 of the holder 90 and the first buffer 110. A screw hole (not shown) through which the coupling part 140 is coupled to the color wheel housing 100 is formed in the color wheel housing 100. When the holder 90 is coupled to the color wheel housing 100, the coupling part 140 can be inserted into the through holes 92a and 110a by aligning the through hole 92a of the housing coupling part 92 and the through hole 110a of the first buffer 110. When the holder 90 coupled to the first buffer 110 is pushed into the color wheel housing 100, the coupling part 140 can be coupled to an inside of the color wheel housing 100 through the screw hole by using tools, such as a driver, etc. A guiding projection (not shown) can be formed on one of the holder 90 and the color wheel housing 100 so that the holder 90 is slidably coupled to the color wheel housing 100. A guiding groove (not shown) can be formed on the other one of the holder 90 and the color wheel housing 100 and may accommodate the guiding projection. Accordingly, coupling and decoupling processes of the holder 90 and the color wheel housing 100 become easy while an operating efficiency becomes increased.

After the coupling process, the color wheel housing 100 accommodating the color wheel 65 can be accommodated in the housing accommodator 70a of the engine housing 70 by sliding into the engine housing 100 through the side opening part 70b of the engine housing 70.

The color wheel housing 100 may have the UV filter 64 disposed at a front part 71 thereof. The color wheel housing 100 can be formed with a sliding projection 101 at upper side thereof so that the color wheel housing 100 slides along the sliding projection 101 toward an inside of the engine housing 70 while a coupling projection 102 of the color wheel housing 100 is coupled to the engine housing 70 through the projection groove 72b. The sliding projection 101 and the coupling projection 102 can project from a surface of the color wheel housing 100. The sliding projection 101 of the color wheel housing 100 can move along a sliding groove 74a formed on the engine housing 70, and then the sliding projection 101 can be accommodated in the housing accommodator 70a. The coupling projection 102 of the color wheel housing 100 can be coupled to a projection groove 72b formed on the side part 72 of the engine housing 70. Thus the color wheel housing 100 can be coupled to the engine housing 70.

A second buffer 120 can be provided between the color wheel housing 100 and the engine housing 70 to prevent the vibration generated by the color wheel 65 from being transmitted to the engine housing 70 through the color wheel housing 100.

The second buffer 120 may comprise a body 121 to be in contact with the color wheel housing 100 and the engine housing 70, and an extending part 122 extended from the body 121 to receive the light tunnel 66. The body 121 and the extending part 122 can be made in a single monolithic body to form the second buffer 120.

A plurality of projection inserting holes 121a positioned to correspond to the projections 72a of the engine housing 70 can be formed on the body 121 of the second buffer 120, and the second buffer 120 can be disposed on the side part 72 of the engine housing 70. A projection passing hole 121b can be formed in the body 121 so that the coupling projection 102 of the color wheel housing 100 can be coupled to the projecting groove 72b of the engine housing 70 through the projection passing hole 121b.

The extending part 122 of the second buffer 120 can be formed with a light tunnel inserting hole 122a in which the light tunnel 66 can be inserted. The light tunnel 66 is in contact with the second buffer 120 so as to prevent the vibration generated by the color wheel 65 from being transmitted to the light tunnel 66 disposed in the engine housing 70.

As described above, a color wheel housing can be formed with a sliding projection to slide into an engine housing, and the engine housing can be formed with a sliding groove. However, it is possible that the color wheel housing can be formed with the sliding groove, and the engine housing can be formed with the sliding projection.

As described above, for coupling the color wheel housing and the engine housing, a coupling projection can be provided on the color wheel housing, and a projection groove can be formed on the engine housing. However, it is possible that the color wheel housing is formed with the projection groove and the engine housing is provided with the coupling projection.

The first, second and third buffers may comprise a rubber material to absorb the vibration or to prevent the vibration from be transferred from one component to another component. Moreover, these buffers may comprise other kinds of vibration absorbing materials.

The panel may comprise a liquid crystal display (LCD), or liquid crystal on silicon (LCOS) as well as the digital micro mirror device (DMD).

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A projection television comprising:
a light source to emit light;
a color wheel to selectively transmit the light emitted from the light source;
an engine housing having a light passage;
a color wheel housing to accommodate the color wheel and to be coupled to the engine housing so that the selectively transmitted light is transmitted along the light passage;
a holder detachably attached to the color wheel housing to rotatably support the color wheel;
a coupling part to couple the holder to the color wheel housing;
a first buffer provided between the holder and the color wheel housing to prevent vibration generated by the color wheel from being transmitted to the color wheel housing through the holder; and
a second buffer provided between the color wheel housing and the engine housing to prevent the vibration generated by the color wheel from being transmitted to the engine housing through the color wheel housing.

2. The projection television of claim 1, wherein the engine housing comprises a light tunnel to uniformize the light which passes through the color wheel, and the second buffer comprises a body to be in contact with the color wheel housing and the engine housing, and an extending part extended from the body and into which the light tunnel is inserted.

3. The projection television of claim 2, further comprising:
a third buffer provided between the coupling part and the holder to prevent the vibration generated by the color wheel from being transmitted to the coupling part through the holder.

4. The projection television of claim 2, further comprising:
a sliding projection formed in one of the engine housing and the color wheel housing to enable the color wheel housing to slide into the engine housing 70; and
a sliding groove formed in the other one of the engine housing and the color wheel housing to be coupled to the sliding projection.

5. The projection television of claim 4, further comprising:
a coupling projection formed in one of the engine housing and the color wheel housing to couple the color wheel housing to the engine housing; and
a projection groove formed in the other one of the engine housing and the color wheel housing to accommodate the coupling projection.

6. The projection television of claim 2, wherein the color wheel housing comprises a plurality of fins formed on a portion thereof to cool down the color wheel housing.

7. The projection television of claim 1, further comprising:
a third buffer provided between the coupling part and the holder to prevent the vibration generated by the color wheel from being transmitted to the coupling part through the holder.

8. The projection television of claim 1, further comprising:
a sliding projection formed in one of the engine housing and the color wheel housing to enable the color wheel housing to slide into the engine housing 70; and
a sliding groove formed in the other one of the engine housing and the color wheel housing to be coupled to the sliding projection.

9. The projection television of claim 8, further comprising:
a coupling projection formed in one of the engine housing and the color wheel housing to couple the color wheel housing to the engine housing; and
a projection groove formed in the other one of the engine housing and the color wheel housing to accommodate the coupling projection.

10. The projection television of claim 1, wherein the color wheel housing comprises a plurality of fins formed on a portion thereof to dissipate heat generated from the color wheel housing.

11. A projection television comprising:
a color wheel;
a holder coupled to the color wheel to rotatably support the color wheel;
a color wheel housing detachably coupled to the holder to accommodate the color wheel; and
a first buffer provided between the holder and the color wheel housing.

12. The projection television of claim 11, further comprising:
an engine housing to accommodate the color wheel housing, and a second buffer provided between the color wheel housing and the engine housing.

13. The projection television of claim 12, further comprising:
a coupling part to couple the holder to the color wheel housing, and a third buffer provided between the coupling part and the holder.

14. The projection television of claim 11, further comprising:
a coupling part to couple the holder to the color wheel housing, and a third buffer provided between the coupling part and the holder.

15. A projection television comprising:
a light source to emit light;
a panel to generate an image beam to form an image;
an engine housing disposed on a light path between the light source and the panel;
a color wheel housing coupled with a color wheel, and slidably inserted into an inside of the engine housing to generate a color beam along the light path using the light so that the panel generates the image beam according to the color beam; and
a buffer attached to the color wheel housing to prevent vibration from being transmitted from the color wheel to the engine housing.

16. The projection television of claim 15, wherein the buffer comprises an extended part having a light tunnel inserting hole, and the engine housing comprises alight tunnel to be inserted into the light tunnel inserted hole of the buffer and to be disposed on the light path.

17. The projection television of claim 16, wherein the buffer comprises a body having an opening in which the color wheel is disposed.

18. The projection television of claim 17, wherein the engine housing comprises a housing accommodator formed therein and an opening formed on a side thereof, and the buffer and the color wheel housing are inserted into and disposed in the housing accommodator of the engine housing through the opening.

19. The projection television of claim 15, wherein the color wheel housing comprises a holder to rotatably support the color wheel, and a coupling part to couple the holder to the color wheel housing.

20. The projection television of claim 19, wherein the color wheel housing further comprises another buffer disposed between the holder and the coupling part to absorb the vibration from the color wheel.

21. The projection television of claim 19, wherein the color wheel housing comprises a first side formed with one or more fins, and a second side to define an opening through which the color wheel housing is inserted into the engine housing.

22. The projection television of claim 19, wherein the color wheel housing and the engine housing comprise a sliding projection and a sliding groove, respectively, to be coupled to each other when the color wheel housing slides into the inside of the engine housing, and the sliding projection and the sliding groove are extended in a direction perpendicular to the light path.

23. A method of a projection television, the method comprising:
disposing an engine housing on a light path between a light source and a panel;
coupling a color wheel to a color wheel housing;
slidably inserting the color wheel housing into an inside of the engine housing so that the color wheel generates a color beam along the light path using light emitted from the light source, and the panel generates an image beam according to the color beam; and
attaching a buffer to the color wheel housing when the color wheel housing is slidably inserted into the inside of the engine housing so that vibration is prevented from being transmitted from the color wheel to the engine housing.
